(19) United States
(12) Patent Application Publication
(10) Pub. No.: US 2026/0195570 A1
(43) Pub. Date: Jul. 9, 2026

(54) IMMUTABLE MEMORY PACKAGES FOR LANGUAGE PROCESSING NEURAL NETWORKS

(71) Applicant: Composable Prompts Corp, New York, NY (US)

(72) Inventors: Eric Barroca, Tokyo-to (JP); Bogdan Stefanescu, Paris (FR)

(21) Appl. No.: 19/013,407

(22) Filed: Jan. 8, 2025

(51) Int. Cl. G06N 3/0475

(52) U.S. Cl. CPC G06N 3/0475

(57) ABSTRACT

Methods, systems, and apparatus, including computer programs encoded on a computer storage medium, for generating an immutable memory package (IMP) for use in processing a request with a large language model (LLM). In one aspect, a method comprises obtaining, by a system that is connected between a client device and one or more external large language models (LLMs), a package definition for a first IMP that includes sets of approved data with assigned fidelity settings from a client device, inserting the one or more sets of approved data into the first IMP in accordance with the assigned fidelity settings, assigning a first version indicator to the first IMP, providing the first IMP to the external LLMs, receiving a request for processing using the first IMP from the client device, and instructing, by the system, at least one external LLM to generate a response to the request using the first IMP.

### BACKGROUND

This specification relates to processing data, and configuring machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can generate an immutable memory package (IMP) for use, e.g., as context, in processing a request with a large language model (LLM). In this specification, an IMP is an immutable, e.g., unmodifiable, data structure that is configured to store one or more sets of approved data that can allow for a controlled response environment for processing requests using an LLM.

In particular, the system is connected between a client device and one or more external large language models (LLMs) that are each configured to process prompts, e.g., directive instructions. In some cases, the prompts relate to a context, e.g., supporting data provided to aid the model in responding to the prompt. More specifically, the system can generate and provide the IMP to at least one LLM among the one or more external LLMs as context for a request, and can instruct the LLM to generate the response using the IMP.

More specifically, the IMP can allow for a controlled response environment based on the data available in the IMP for conditioning the responses of the LLM. By processing the data in the IMP, the LLM is guaranteed to generate responses that are conditioned on the exact same data each time, thereby providing for a controlled response environment specific to the data stored in the IMP.

According to a first aspect there is provided a method for obtaining, by a system that is connected between a client device and one or more external large language models (LLMs), a package definition for a first immutable memory package (IMP), wherein the definition of the first IMP specifies one or more sets of approved data to be included in the first IMP, and for each of the one or more sets of approved data, an assigned fidelity setting indicating a level of fidelity at which the set of approved data will be included in the first IMP, inserting, by the system and based on the package definition, the one or more sets of approved data into the first IMP, wherein each given set of approved data is inserted at the level of fidelity corresponding to the assigned fidelity setting for the given set of approved data, assigning, by the system, a first version indicator to the first IMP, wherein the first version indicator uniquely identifies the first IMP that includes the stored one or more sets of approved data, providing, by the system, the first IMP to the one or more external LLMs, after providing the first IMP to the one or more external LLMs, receiving, by the system, a request for processing using the first IMP from the client device, in response to receiving the request, instructing, by the system, at least one LLM from among the one or more external LLMs to generate a response to the request using the first IMP that was already provided to the at least one LLM without again providing the first IMP to the one or more external LLMs.

In an example implementation, the method further includes generating the one or more sets of approved data based on interactions with at least one LLM among the one or more external LLMs.

In an example implementation, generating the one or more sets of approved data includes transmitting a first set of instructions to the at least one LLM to perform a first set of information processing, receiving a first set of results generated by the at least one LLM performing the first set of information processing, transmitting a second set of instructions to the at least one LLM to perform a second set of information processing based on the first set of results and the second set of instructions, receiving a second set of results generated by the at least one LLM performing the second set of information processing, and defining the second set of results as a first set of approved data among the one or more sets of approved data, wherein inserting the one or more sets of approved data into the first IMP includes inserting the second set of results into the first IMP.

In an example implementation, the method further includes generating a new IMP version based on the one or more sets of approved data in the first IMP and a response generated by at least one LLM.

In an example implementation, generating the new IMP version includes adding data from the response generated by the at least one LLM to the one or more sets of approved data in the first IMP to obtain a new IMP, assigning, to the new IMP, a new version indicator that uniquely identifies the new IMP and differentiates the new IMP from the first IMP, and providing the new IMP to the one or more external LLMs.

In an example implementation, the method further includes instructing at least one external LLM among the one or more external LLMs to perform information processing, wherein the instructions specify one of the first version indicator or the new version indicator as an indication of which of the first IMP or the new IMP the at least one external LLM will use to perform the information processing without again providing either of the first IMP or the new IMP to the at least one external LLM.

In an example implementation the method further includes obtaining the one or more sets of approved data to be included in the first IMP.

In an example implementation, the method further includes obtaining one or more additional sets of approved data from the client device, adding the one or more additional sets of approved data to the one or more sets of approved data in the first IMP to obtain a new IMP, assigning, to the new IMP, a new version indicator that uniquely identifies the new IMP and differentiates the new IMP from the first IMP, and providing the new IMP to the one or more external LLMs.

In an example implementation, the request further includes an indication to use at least one of the sets of approved data in the first IMP as context for the request, and wherein, in response to receiving the request, instructing, by the system, further includes instructing the at least one LLM to generate a response to the request using the context for the request.

In an example implementation, the indication to use at least one of the sets of approved data further includes the identification of the at least one of the sets of approved data, and wherein the at least one LLM generates a response to the request using the context for the request through operations including identifying the at least one of the sets of approved data in the first IMP as the context for the request.

In an example implementation, the at least one LLM identifies the at least one of the sets of approved data in the first IMP as context through operations including determining a respective measure of relevance with respect to the request for each of the sets of approved data in the first IMP, selecting the at least one set of approved data from the first IMP based on the respective measures of relevance.

In an example implementation, determining the respective measures of relevance with respect to the request for each of the sets of relevant data includes generating a respective content embedding of each of the sets of approved data using an embedding neural network, generating a request embedding of the request using the embedding neural network, determining the respective measures of similarity between the request embedding and each of the respective content embeddings as the respective measure of relevance for each of the one or more sets of approved data.

In another aspect, there is provided a system comprising one or more computers and one or more storage devices storing instructions that are operable, when executed by the one or more computers, to cause the one or more computers to perform the method of any one of the example implementation methods described.

In an example implementation, the first IMP includes a high-fidelity memory configured to store a first subset of the one or more content data items, and a low-fidelity memory configured to store a second subset of the one or more content data items with less detail than the high-fidelity memory.

In another aspect, there is provided a computer storage medium encoded with a computer program, the program comprising instructions that are operable, when executed by data processing apparatus, to cause the data processing apparatus to perform the method of any one of the example implementation methods described.

In an example implementation, the first IMP includes a high-fidelity memory configured to store a first subset of the one or more content data items, and a low-fidelity memory configured to store a second subset of the one or more content data items with less detail than the high-fidelity memory.

Particular embodiments of the subject matter described in this specification can be implemented so as to realize one or more of the following advantages.

The system of this specification provides for the generation of an IMP, a portable and immutable package of data that can be easily provided to an LLM, e.g., as context for response generation in a controlled environment.

A technical problem overcome by the solutions presented in this specification is the problem of statelessness in LLM response generation. More specifically, LLMs are unaware of prior inputs and prior responses and are required to reprocess any context that was provided, e.g., in a prior input to the LLM as well as the responses previously generated, in order to generate additional responses conditioned on the previous context and responses. Since most applications involving LLMs require conditioning on previous context and responses, the fact that LLMs are stateless can lead systems to actively fetch responses in order to prepare the context dynamically, e.g., which involves a large allocation of computational resources and memory.

In contrast, the system of this specification can provide an IMP to an LLM as an immutable and portable package of data that can be used as context, e.g., to respond to one or more requests that relate to the context included in the IMP. In particular, the system can generate and transmit the IMP to an LLM in a single transmission and can bypass the need to process and store intermediate results, e.g., thereby reducing the use of computational resources compared to actively querying, fetching, and preparing the context with every processing call to an LLM in order to generate the context dynamically. In this way, the amount of data needed to be transmitted to the machine learning models and the amount of data required to be stored to generate the context is reduced relative to preparing the context dynamically.

Moreover, the present solutions enable relevant outputs to be generated by the machine learning models in response to requests/instructions provided to the machine leaning models based on the controlled response environment provided by the IMP. In particular, dynamically preparing the context can result in inconsistent results, e.g., since the context provided to the LLM at each processing call is generated before each processing call. In contrast, an LLM can receive an IMP and effectively initialize a controlled response environment based on the immutable sets of data in the IMP each time the IMP is used for processing a request. More specifically, the system allows for the creation of predefined, e.g., vetted and approved information, in an IMP that can be provided as context for an LLM, such that the LLM is guaranteed to condition response generation using the exact same data each time the IMP is used by the LLM to generate responses.

While the IMPs are immutable, the system also allows for the versioning of IMPs, e.g., to support the inclusion of additional information in a new version of an IMP. The system can assign a unique identifier to the IMP, and can maintain the IMPs, e.g., in a database, to facilitate the generation of new versions of IMPs from previous version of the IMPs. As an example, the system can generate a new version of an IMP using the sets of approved data from a previous version of an IMP with additional sets of approved data, e.g., in some cases, data generated through further interactions with an LLM. The system can then assign a new unique identifier and provide the new IMP in a single transmission to an LLM for use. The use of versioning provides further advantages because the information sent to the LLM is fully traceable, thereby enabling data lineage analysis.

In addition to the foregoing advantages, the solutions described herein also provide memory management advantages by allowing for the storage of information in either high fidelity memory or low fidelity memory based on the level of detail needed for the particular information. For example, where only general concepts are needed to provide adequate context, that information can be stored in low fidelity memory, thereby requiring a smaller memory footprint, whereas when more details are needed to provide adequate context to the LLM, that information can be stored in high fidelity memory. Over time, information that was once stored in high fidelity information may become less important for providing context to the LLM (e.g., the information has become more common knowledge and/or accounted for by the finetuned or trained LLM). In that situation, the system can move the information from high fidelity memory to low fidelity memory to save memory space and/or reallocate that freed up high fidelity memory to a new concept for which more detailed information is required to provide adequate context to the LLM.

In at least these ways, the presently described and claimed solutions improve the functioning of a machine learning system itself.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a system diagram of an example LLM request management system that connects a client device and one or more external LLMs.

FIG. 2 is a system diagram of example IMP generation and versioning subsystem.

FIG. 3 is a flow diagram of an example process for generating an IMP and providing the IMP for use in generating a response to an LLM.

FIG. 4 is a flow diagram of an example process for generating a new version of an IMP.

FIG. 5 illustrates an example of a computing device and a mobile computing device that can be used to implement the techniques described here.

Like reference numbers and designations in the various drawings indicate like elements.

### DETAILED DESCRIPTION

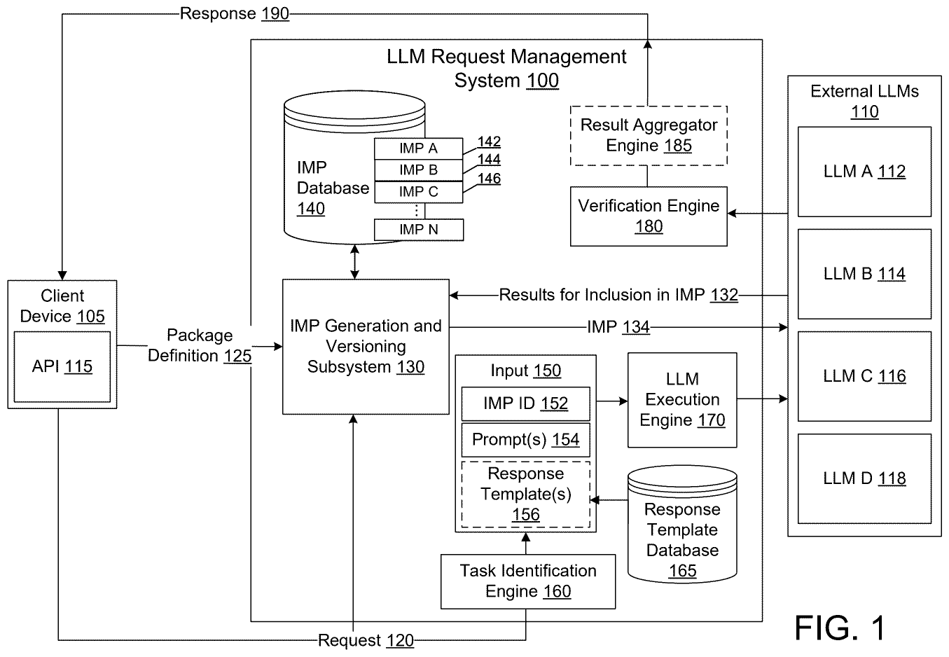

FIG. 1 shows an example LLM request management system 100. The LLM request management system 100 is an example of a system implemented as computer programs on one or more computers in one or more locations in which the systems, components, and techniques described below are implemented.

The LLM request management system 100 can connect a client device 105 and one or more external large language models (LLMs) 110. In particular, the system 100 can receive a request 120 from the client device 105, can determine an execution strategy for the request 120, and can provide for the configuration of an input 150 to at least one of the one or more LLMs 110 based on the execution strategy for the request 120, e.g., using at least one of the one or more external LLMs 110. As an example, the client device 105 can be a server, a laptop, a tablet computer, a desktop, or a mobile device. As another example, the client device 105 can be a wearable device, e.g., a smart-watch, or an internet of things (IoT) device.

Each LLM in the external LLMs 110, e.g., LLM A 112, LLM B 114, LLM C 116, and LLM D 118, can have a recurrent neural network architecture that is configured to sequentially process the contents of an input, e.g., a prompt, and trained to perform next element prediction, e.g., to define a likelihood score distribution over a set of next elements. More specifically, each LLM can be a transformer-based model, e.g., an encoder-decoder transformer, an encoder-only transformer, or a decoder-only transformer, that is configured to perform parallel processing of the contents of the multimodal input using a multi-headed attention mechanism. In particular, each large language model can be configured to process a sequence of input tokens and to predict a sequence of output tokens using a likelihood score distribution over a set of next elements based on the previously predicted output tokens.

In particular, the external LLMs 110 can be implemented with the same neural network architecture or with different neural network architectures. For example, LLM A 112 and LLM B 114 can be implemented with a first architecture, e.g., a Generative Pretrained Transformer (GPT) architecture, LLM C 112 can be implemented with a second architecture, e.g., a Text-to-Text Transfer Transformer (T5) architecture, and LLM D 118 can be implemented with a third architecture, e.g., a Bidirectional Encoder Representations from Transformer (BERT). As another example, a subset of the LLMs in the external LLMs 110 can have been finetuned from a foundational model for particular tasks in a mixture-of-experts model.

In some cases, one or more of the external LLMs 110 are multi-modal LLMs, e.g., that are configured to process one or more of a text modality, an image modality, an audio modality, or a video modality. For example, the external LLMs 110 can include a vision transformer, a contrastive language-image pretraining (CLIP) model, or a DALL-E model.

More specifically, the system 100 can configure an input 150 to one or more of the external LLMs 110 using the request 120. In particular, the system 100 can determine an execution strategy to execute the request 120 using the external LLMs 110. More specifically, the system 100 can determine one or more prompts 154 from the request 120, provide for the design of response templates 156 as example output formatting for the LLMs 110, and can specify the identifier of an immutable memory package (IMP) to be used for processing the request 120. The system 100 can then route the input 150 to one or more of the external LLMs 110.

In this context, an immutable memory package (IMP) is an immutable, e.g., unmodifiable, data structure that is configured to store one or more sets of approved data according to a package definition 125 received from a client device, e.g., by way of an applied programming interface (API) 115, for processing using an LLM. For example, the API 115 can enable a user, e.g., the user of the client device 105, to input requests and content to the system for inclusion in an IMP as a package definition 125. As an example, the API 115 can be provided to the user over a network, e.g., the internet.

In the case that the system 100 receives a package definition 125, the package definition can specify one or more sets of approved data. In this case, the sets of data are approved, e.g., since the sets of approved data were selected for inclusion in an IMP. As an example, a user of the client device 205 can have previously evaluated the sets of data selected for inclusion in the IMP. More specifically, since the IMP defined by the package definition 205 will be used to provide a controlled response environment for an LLM, the package definition can include data that has been evaluated and approved for use in the controlled response environment.

For example, the one or more sets of approved data can include a set of one or more electronic documents, a set of one or more images, a set of one or more videos or audio clips, to be included in the IMP. In particular, each of the sets of approved data can include context for an LLM. In some cases, the sets of approved data can include one or more textual electronic documents, e.g., a file, a portion of the file, or multiple files that include(s) data that causes presentation of a set of textual content at a client device. In this case, e.g., a book, a legal document, a webpage, etc. can be included as approved data.

In some cases, the system 100 can obtain the one or more sets of approved data, e.g., from the client device 105. In other cases, the system 100 can generate the one or more sets of approved data, e.g., based on interactions with at least one of the external LLMs 110. As an example, the system 100 can generate a set of data that includes one or more prompt-response pairs of one or more example interactions with the at least one LLM. In yet another case, the system 100 can obtain the sets of approved data both from the client device and based on one or more interactions with one of the external LLMs 110.

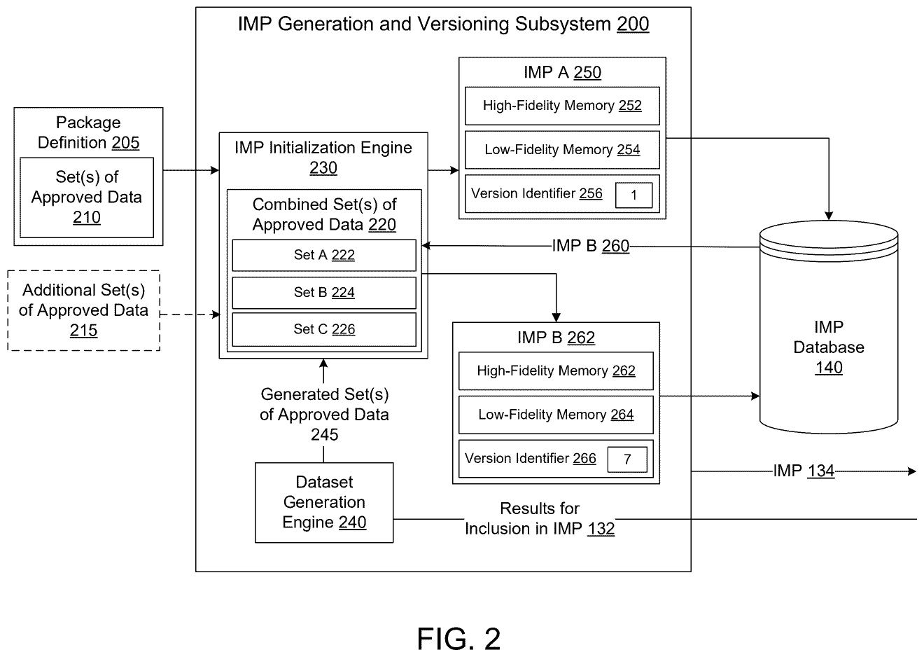

The package definition 125 can also include a corresponding assigned fidelity setting indicating a level of memory fidelity at which each set of approved data should be included in the IMP. In this case, memory fidelity refers to the accuracy and precision with which information is represented in the memory storage of the IMP, e.g., at either a high or a low fidelity. In some cases, the low fidelity setting represents a compressed storage option, e.g., a set of approved data can be compressed using a known compression algorithm for storage in the IMP, and the high fidelity setting represents a full precision storage option, e.g., without compression. In other cases, the high fidelity and low fidelity settings represent different compression options, e.g., compression using a lossless and lossy compression algorithm, respectively, e.g., as will be described in more detail with respect to FIG. 2. In particular, the API 115 can allow the user of the client device 105 to configure each of the sets of approved data with an assigned fidelity.

In this case, the system 100 can process the package definition 125 using an IMP generation and versioning subsystem 130. In particular, the system 100 can process the package definition 125 to generate an IMP, e.g., the IMP 134, including the one or more sets of approved data specified by the package definition 125, e.g., by inserting each of the sets of approved data at the corresponding memory fidelity indicated by the respective assigned fidelity settings. In the case that the system 100 generates at least one of the sets of approved data, the subsystem 130 can receive and process results 132 from one of the external LLMs 110 for inclusion in the IMP 134, e.g., by adding data from a response generated by the at least one LLM in an additional set of approved data After generating the IMP, the subsystem 130 can provide the IMP to at least one of the external LLMs 110 for processing, e.g., as will be described in further detail below. An example IMP generation and versioning subsystem 130 will be described in more detail with respect to FIG. 2.

Additionally, the IMP generation and versioning subsystem 130 can generate a unique identifier for each IMP, e.g., to facilitate the identification of the IMP in a data storage location. In the particular example depicted, the system 100 can maintain generated IMPs, and, e.g., associated metadata, in an IMP database 140. As an example, the IMP database 140 can include structured data, e.g., version tables, that correspond with each IMP. In particular, the IMP database 140 can include tables that correspond with a particular IMP and include data for each of the versions of the particular IMP, e.g., an IMP A table 142 that includes any versions of IMP A, e.g., IMP A version one, two, three, four, etc., an IMP B table 144 that includes any versions of IMP B, and an IMP C table 146 that includes any versions of IMP C.

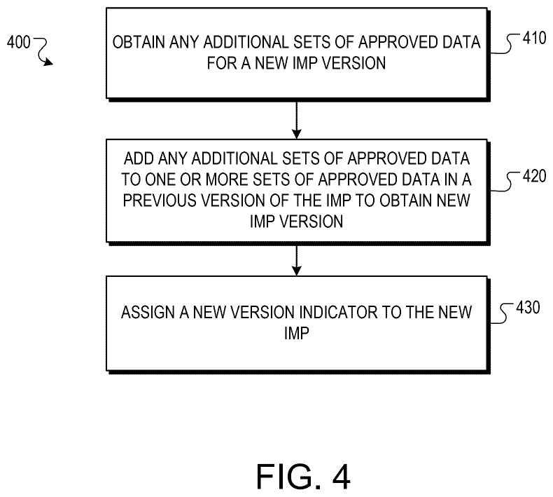

The system 100 can maintain generated IMPs, e.g., the IMP 134, in the database 140 to facilitate the generation of new versions of IMPs. More specifically, the subsystem 130 can identify a previous version of a particular IMP to generate any new versions of the particular IMP, e.g., to include any additional sets of approved data obtained from the client device 105, through interactions with at least one of the LLMs 110, or both. Generating a new version of an IMP will be described in more detail with respect to FIGS. 2 and 4.

Each time the IMP generation and versioning subsystem 130 generates a new IMP 134, the subsystem 130 can provide the IMP 134 to at least one of the external LLMs 110. In particular, the subsystem 130 need only provide the IMP 134 to the external LLMs 110 one time since the IMP 134 is immutable. More specifically, the system 100 can maintain consistency for processing by providing the IMP 134 to the external LLMs 110. This differs from conventional systems in which the data providing context to the LLM is required to be provided to the LLM each time a request is sent to the LLM, such that the present solution reduces the amount of data that needs to be transferred over the network relative to conventional systems that do not use the IMP of the present system 100.

Since LLMs are stateless, the IMP 134 is a portable unmodifiable “state” that includes approved sets of data as context for the external LLMs 110 to use for each processing iteration that relates to the data stored in the IMP 134. Furthermore, as referenced above, the system 100 can save bandwidth and reduce latency by providing the IMP 134 to the external LLMs 110 in a single transmission for use in processing requests, e.g., in contrast to providing the IMP 134 to the external LLMs 110 in response to a request for processing, e.g., the request 120, using the IMP 134 each time or preparing the context dynamically with every call. More specifically, the system 100 can instruct at least one of the external LLMs 110 to generate a response to the request 120 using the IMP 134 that was already provided to the at least one LLM without again providing the first IMP to the one or more external LLMs 110.

For example, the request 120 for processing using the IMP 134 can include a directed instruction that relates to one or more of the sets of approved data that are included in the IMP 134. In particular, the system 100 can provide for the identification of the relevant IMP 134 in the input 150, e.g., using an IMP ID 152 that specifies the particular IMP and the version of the particular IMP. For example, the request 120 can include the identification of the IMP 152 that should be processed as context for the request 120. As another example, the IMP generation and versioning subsystem 130 can use the request 120 to identify the relevant IMP ID 152 from the IMP database 140. As used herein, the IMP ID 152 refers to an identifier of a particular IMP.

The input 150 can include the relevant IMP ID 152 and one or more prompt(s) 154 corresponding with the request 120 for processing using the IMP 134. In particular, the system 100 can process the request 120 to determine one or more prompts 154, e.g., directive instructions to complete a particular task corresponding with the request 120, using a task identification engine 160. In this case, each task identified by the engine 160 can be included in a separate prompt. As an example, the task identification engine 160 can process the request 120, determine one or more tasks from the request 120, and generate one or more prompts 154 corresponding with the request. As another example, the engine 160 can process the request 120, decompose the request 120 into a set of sub-requests, and determine respective prompts 154 for each of the sub-requests.

For example, the request 120 can be decomposed into one or more tasks for a particular LLM, e.g., as a sequence of prompts in a chain-of-thought framework that decomposes a complex task into a sequence of related sub-tasks that an LLM can consecutively perform to effectively complete the complex task. As another example, the request 120 can be decomposed into tasks that each correspond with different finetuned LLMs, e.g., to take advantage of a mixture-of-experts model included in the external LLMs 110.

In some cases, the input 150 can additionally include one or more response template(s) 156, e.g., an example of the desired structure for the output in response to the prompt(s) 154. As an example, a response template for a particular prompt can include a rephrasing of the prompt, a main response, a summary of the response, and suggested next steps with respect to how the prompt relates to the response. In the case that the task identification engine 160 has decomposed the request 120 into a sequence of prompts in a chain-of-prompt framework, the system 100 can include respective response templates 156 for each of the prompts 154 in the sequence of prompts that facilitate the consecutive prompting of an LLM.

For example, the system 100 can receive the response template(s) 156 from the client device 105, e.g., by way of the API 115. In particular, the system 100 can provide an API 115 that allows for the configuration of a response template 156 for the request 120. In this case, a user of the client device 105 can specify a particular response template 156 for the request 120.

As another example, the system 100 can identify one or more response template(s) 156, e.g., from previously used response template(s) maintained in a response template database 165. More specifically, the system 100 can store previously received response templates with associated data indicating the purpose of the template in the database 165. In some cases, the system 100 can use the external LLMs 110 to generate response templates, e.g., by prompting one or more of the external LLMs 110 to generate a response template for a given prompt, and storing the response templates in the database 165.

After obtaining the IMP ID 152, determining the prompt(s) 154, and identifying response template(s) 156 necessary to respond to the request 120 for processing using the IMP 134 as the input 150, the system 100 can process the input 150 using an LLM execution engine 170 and provide the input 150 to at least one of the external LLMs 110. For example, the LLM execution engine 170 can include a router that routes respective jobs for the input 150, where each job includes inputting corresponding relevant portion(s) of context 152, a prompt from the prompt(s) 154, and, in some cases, a response template from the response template(s) 156 to an external LLMs 110.

In particular, the LLM execution engine 170 can determine the execution strategy for the input 150, e.g., based on any relationships in the prompt(s) 154. As an example, the engine 170 can identify whether any of the one or more prompt(s) 154 can be executed parallel, e.g., by providing independent prompt(s), e.g., with corresponding context 152 and response template 156, to separate external LLMs 110. As another example, the engine 170 can determine whether a particular LLM in the external LLMs 110 is better-suited to perform the task represented by a particular prompt, e.g., due to the particular LLM having been specialized for the task through finetuning. In this case, the engine 170 can provide the particular prompt to the particular LLM for the specialized task.

As yet another example, the engine 170 can designate whether any of the one or more prompt(s) 154 should be executed by multiple LLMs. As an example, the engine 170 can provide an additional input to the multiple LLMs to indicate that the LLM is part of a multiple-participant processing job for the prompt and to request that each of the multiple LLMs additionally process the generated results from all of the participating LLMs in the multiple-participant processing job to generate an indication of the value of the responses, e.g., by voting on a best response or assigning a score to the responses.

In particular, the engine 170 can provide the input 150 to at least one of the external LLMs 110 to generate responses to the prompt(s) 154 based on the data included in the IMP 134 specified by the IMP ID 152. Since LLMs are stateless, the LLM can use the IMP 134 to initialize a controlled response environment using the data included in the IMP 134 as context. For example, the LLM can use the IMP 134 to generate more accurate responses based on sets of approved data that are included in the IMP as context for specialized tasks, e.g., a legal document analysis task, a project management a workflow automation task, a code generation task, or a customer support task.

In some cases, the system 100 can include an additional instruction in the prompt(s) 154 to identify one or more particular set(s) of approved data in the IMP 134 specified by the IMP ID 152 as the context for the prompt. For example, the instruction to identify a particular set of approved data in the IMP 134 can include an identification of the set(s) of approved data, e.g., a particular approved set of images, a slideshow presentation, documentation for a project, etc. In this case, the LLM that receives the prompt can identify the set(s) of approved data specified as context, e.g., based on the identification given in the prompt.

As another example, the LLM that receives the prompt can identify one or more of the set(s) of approved data by determining a measure of relevance for each of the sets of approved data in the IMP 134 specified by the IMP ID 152 with respect to the request 120, and can select one or more of the set(s) of the approved data based on the respective measures of relevance. For example, in this case, the LLM can generate a respective content embedding of each of the sets of approved data and the request 120, e.g., using an embedding neural network, and can determine the respective measures of similarity between the request embedding and each of the respective content embeddings as the respective measure of relevance for each of the one or more sets of approved data.

After providing the input 150 for processing using at least one of the external LLMs 110, the system 100 can then receive the one or more response(s) from the LLMs 110 corresponding to the input 150. In particular, the system 100 can verify the completion of the execution strategy for the request 120 using a verification engine 180. For example, the verification engine 180 can determine whether a response was received for each of the prompt(s) 154 in the input 150. In the case that any response is missing, the system 100 can re-execute the one or more prompt(s) corresponding with the missing responses. As another example, in the case that the prompt(s) 154 were accompanied by a response template(s) 156 in the input 150, the verification engine 180 can determine whether the responses received adhere to the relevant response template(s) 156.

In the case that any of the prompt(s) 154 need to be re-executed, since the data in the IMP 134 is immutable, the LLM can use the IMP 134 to reinitialize the same controlled response environment. More specifically, the LLM can return to the same “state” before processing the prompt using the exact same data each time the LLM uses the IMP 134.

The system 100 can also use the verification engine 180 to provide for workflow monitoring regarding inputted requests, e.g., the request 150. For example, the verification engine 180 can log data regarding the responses received for different inputs 150. As an example, the system 100 can analyze the data, e.g., to support online improvement of the system, or to provide a user of the client device 105 with information regarding which execution strategies were most effective for responding to the request 120.

In the case that the system 100 receives a single response from the external LLMs 110 and verifies the response with the verification engine 180, the system 100 can provide the response 190 to the client device 105. In the case that the system 100 receives multiple responses from the external LLMs 110, after verifying the responses with the engine 180, the system 100 can process the responses using a result aggregator engine 185, e.g., to synthesize the results. In this case, the result aggregator can combine the responses into an aggregated response and provide the aggregated response to the client device 105 as the response 190.

FIG. 2 is a system diagram of example IMP generation and versioning subsystem 200. For example, the IMP generation and versioning subsystem 135 of the LLM request management system 100 of FIG. 1 can be implemented as the IMP generation and versioning subsystem 200.

As depicted in FIG. 1, the IMP generation and versioning subsystem 200 can receive a package definition 205 specifying one or more set(s) of approved data 210 with respective corresponding assigned fidelity settings, e.g., indicating a level of fidelity at which each set of approved data specified in the package definition 205 should be included in the IMP. In the particular example depicted, the package definition 205 includes the set(s) of approved data 210 for inclusion in an IMP. In this case, the subsystem 200 can process the package definition 205 using an IMP initialization engine 230 to generate an IMP object, e.g., IMP A 250.

The system can assign a corresponding version indicator to IMP A 250, e.g., the version identifier 256. More specifically, since this is the first instance of IMP A 250, the subsystem 200 can assign a version indicator that indicates that the IMP A 250 is the first version of IMP A. In this case, the subsystem 200 assigns “1” as the indicator which corresponds directly with the version number. In other cases, the subsystem 200 can assign an indicator in any arbitrary way, as long as the version indicator remains unique for all versions of IMP A.

In particular, the IMP initialization engine 230 can initialize a data object that includes both a high-fidelity memory 252 and a low-fidelity memory 254 storage as the IMP A 250. In particular, the high-fidelity memory 252 can ensure that the approved sets of data are stored without alteration and with high data accuracy, whereas the low-fidelity storage can store the approved data sets at reduced data accuracy. For example, the engine 230 can insert the sets of approved data indicated for high-fidelity storage in the high-fidelity memory 252 by storing the data in a high-fidelity data structure, or by compressing the data using a lossless compression algorithm and inserting the compressed data in the high-fidelity memory 252. As another example, the engine 230 can insert the sets of approved data indicated for low-fidelity storage in the low-fidelity memory 252 using a data structure that does not support high-fidelity storage, or by compressing the data using a lossy compression algorithm and inserting the compressed data in the low-fidelity memory 254.

In this context, compressing the data refers to reducing the data size for storage by compromising the data fidelity. For example, the engine 230 can implement one or more lossless compression algorithms, e.g., Huffman coding, LZ77, or Z-standard algorithms, etc. to compress the sets of approved data for high-fidelity memory 252. As another example, the engine 230 can implement one or more lossy compression algorithms, e.g., JPEG, MP3, or HEVC, etc. to compress the sets of approved data for low-fidelity memory 252. In particular, the subsystem 200 can identify the relevant compression algorithm for the type of data in the sets of approved data, e.g., JPEG applies to images, MP3 applies to audio, and HEVC applies to videos, and apply the relevant compression algorithm for each of the sets of approved data.

In some cases, the subsystem 200 can additionally receive results 132 for inclusion in the IMP A 250 as a set of approved data. In particular, the system can have generated the results 132 by interacting with at least one of the external LLMs, e.g., by providing any number of inputs to an LLM to receive one or more responses. For example, the system can transmit one or more instructions to the LLM to perform a first information processing task, can receive the results for the first information processing task, and can transmit one or more additional instructions to the LLM to perform a second information processing task. The system can then receive the results generated for the second information processing task for inclusion in the IMP, e.g., as the results 132, which can be provided to the subsystem 200 for inclusion in the IMP.

In this case, the subsystem 200 can process the results for inclusion in the IMP A 250 using a dataset generation engine 240 to collate the results into one or more generated set(s) of approved data 245 for the IMP A 250. In particular, the engine 240 can process the results 132 to identify one or more responses or prompt-response pairs for inclusion in a set of approved data 245. For example, the engine 240 can receive results 132 that the system generated by providing the same input to each LLM in the external LLMs multiple times with instructions to generate diverse responses to the prompt, e.g., generating text for a document. In this case, the engine 240 can evaluate the multiple responses, e.g., using an additional LLM, to determine whether each of the responses satisfies one or more quality criterion for inclusion in the generated set(s) of approved data 245. In particular, the quality criterion can be defined based on the task specified by the prompt. As another example, in the case that a response template, e.g., one of the response templates 156 of FIG. 1, was provided to the LLM in the input, the engine 240 can use the response template to identify and extract different subsets of the results 132 for inclusion in the generated set(s) of approved data 245.

In this case, the subsystem 200 can combine the obtained set(s) of approved data 210, e.g., obtained from the client device as part of the package definition 205, and the generated set(s) of approved data 245, e.g., generated based on interactions with at least one LLM of the external LLMs, into the combined set(s) of approved data 220. As an example, the subsystem 200 can have obtained the set of approved data A 222 and B 224 from the package definition 205 and can have generated the set of approved data 226 from one or more interactions with one of the external LLMs that resulted in the results 132.

In this case, the subsystem 200 can process the combined set(s) of approved data 220 and the package definition 205 using the IMP initialization engine 230 to initialize an IMP object and insert each of the sets of approved data 222, 224, and 226 in the memory fidelity specified by the corresponding fidelity settings. In some cases, the package definition 205 can specify the fidelity setting for the set(s) of approved data that was generated based on interactions with at least one of the LLMs. As another example, the system can be configured with a default fidelity setting that specifies the fidelity setting for sets of approved data that are not associated with a particular fidelity setting in the package definition 205, e.g., a high-fidelity setting.

After generating an IMP, e.g., the IMP A 250, the subsystem 200 can provide the IMP A 250 to one or more of the external LLMs for use in response generation. The subsystem 200 can also provide the IMP A 250 to an IMP database 140. In particular, the system 100 can maintain each of the generated IMPs in the database 140 to facilitate the generation of a new version of the IMP from a previous version of the IMP. For example, the subsystem 200 can generate a new version of the IMP from the most previous version of the IMP, or from a specific version of the IMP.

In particular, the subsystem 200 can identify a particular version of an IMP from the database 140, e.g., by locating a corresponding version table for the particular IMP in the database 140 and identifying the previous version of the IMP. More specifically, the subsystem 200 can identify the previous version of the IMP in the version table using the version indicator of the IMP. The subsystem 200 can then use the identified previous version of the IMP to generate a new version of the IMP based on the one or more sets of approved data in the previous version of the IMP.

For example, the IMP generation and versioning subsystem 200 can generate a new version of the IMP in response to obtaining any additional set(s) of approved data obtained from the client device, based on a response generated by at least one LLM, or both. In particular, the system can receive a request to update a particular IMP, e.g., from the client device that submitted the package definition 205, that includes the additional set(s) of approved data 215. In some cases, the system can be granted access to a data repository on the client device, e.g., to retrieve the additional set(s) of approved data 215 for inclusion in the new version of the IMP.

As another example, the subsystem 200 can receive a request to update a particular IMP, e.g., from the client device that submitted the package definition 205, with an instruction to generate a new version of the IMP using a response generated by at least one LLM in the external LLMs. In this case, the additional set of data can include one or more responses or prompt-response pairs of one or more example interactions with at least one of the external LLMs.

More specifically, the subsystem 200 can generate a new version of the IMP from interactions with at least one LLM using the previous version of the IMP, e.g., the first version of the IMP. In particular, the subsystem 200 can process the results 132 for inclusion in the IMP 134 using the dataset generation engine 240, as is discussed above, to generate an additional set of approved data that can be added to the sets of approved data in the previous version of the IMP. For example, the subsystem 200 can generate a new IMP based on one or more responses or the prompt-response pairs of an example interaction with at least one of the external LLMs.

In the particular example depicted, the subsystem 200 can generate a new version of IMP B, e.g., in response to a request to generate a new version of IMP B. For example, the subsystem 200 can identify a previous version of IMP B, e.g., IMP B 260, in the IMP database 140, e.g., by identifying the version table corresponding with IMP B and selecting an IMP version. For example, the subsystem 200 can identify the most recent version of IMP B to use for generating the new version. As another example, the subsystem 200 can identify a particular previous version, e.g., using the version indicator, e.g., the version identifier corresponding with the particular previous version.

In this case, the subsystem 200 can obtain the one or more sets of approved data from the most recent version of IMP B, e.g., version six IMP B 260, and can initialize a new version of IMP B, e.g., the IMP B 262, using the IMP initialization engine 230. In particular, the subsystem 200 can use the IMP initialization engine 230 to insert each of the sets of approved data from IMP B 260 into the corresponding high 262 and low 242 fidelity memory of the new IMP B 262 as specified by the assigned fidelity settings used to generate IMP B 260.

The engine 230 can insert the additional set(s) of approved data 215 into the new IMP B 262. In particular, the engine 230 can add the additional set(s) of approved data 215 obtained from the client device, the additional set(s) of approved data generated using the results 132, or both to the one or more sets of approved data in the previous version of IMP B 260 to obtain the new IMP B 262. For example, the engine 230 can insert each additional set of approved data according to a corresponding assigned fidelity setting included in the request to generate a new version or based on a predefined default fidelity system setting. The subsystem 200 can also assign a new version indicator, e.g., the version identifier 266 to the new version of IMP B 262. In this case, the version identifier 266 is seven since IMP B 262 is the seventh version of IMP B.

After generating a new version of IMP B 262, the subsystem 200 can provide IMP B 262 to at least one of the external LLMs. For example, the system 200 can instruct an LLM in the external LLMs to use IMP B 262 to process a prompt by including the IMP identifier including the version identifier in the input that is provided to the LLM. More specifically, the system can instruct at least one of the external LLMs to perform information processing using either the previous or new IMP version based on the inclusion of the corresponding version indicator in the instruction without again providing either of the previous version of the IMP or the new version of the IMP to the LLM. The subsystem 200 can additionally provide the IMP B 262 to the IMP database 140, e.g., for use in the generation of future versions of IMP B.

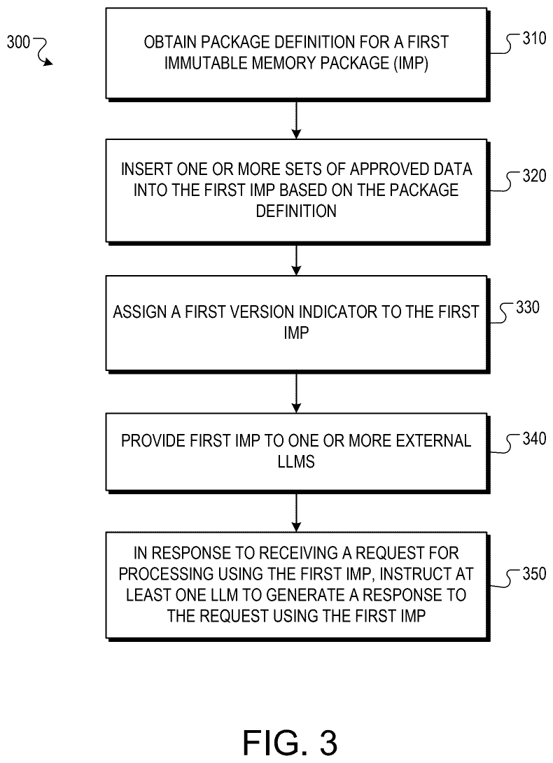

FIG. 3 is a flow diagram of an example process 300 for generating an IMP and providing the IMP for use in generating a response to an LLM. For convenience, the process 300 will be described as being performed by a system of one or more computers located in one or more locations. For example, an LLM request management system, e.g., the LLM request management system 100 of FIG. 1, that is connected between a client device and one or more external large language models (LLMs) and is appropriately programmed in accordance with this specification, can perform the process 300. Operations of the process 300 can be implemented, for example, as instructions stored on one or more non-transitory computer-readable medium that, upon execution by one or more computing devices, cause the one or more computing devices to perform operations of the process 300.

As previously discussed, the one or more external LLMs can each be external to the system that performs operations of the process 300. For example, any or all of the one or more external LLMs can be commercially available LLMs that are developed by third parties that differ from the entity providing the system that performs operations of the process 300. The system that performs operations of the process 300 can also include one or more LLMs.

The system can obtain a package definition for a first immutable memory package (IMP) (step 310), e.g., from a client device. For example, the package definition for the first IMP can specify one or more sets of approved data, e.g., a set of one or more electronic documents, a set of one or more images, a set of one or more videos or audio clips, to be included in the first IMP. More specifically, the IMP can be used for processing with a large language model (LLM), e.g., to provide a consistent controlled response environment for processing requests using the LLM.

In particular, each of the one or more sets of approved data can be configured with an assigned fidelity setting that indicates the level of memory fidelity at which the set of approved data will be included in the IMP. In this case, memory fidelity refers to the accuracy and precision with which information is represented in computational storage. As an example, the package definition can be configured to designate one or more of the sets of approved data for storage in high-fidelity memory, e.g., memory that stores data at a higher resolution and in greater detail than a low-fidelity memory. As another example, the package definition can be configured to designate one or more of the sets of approved data for storage in low-fidelity memory, e.g., in the case that the one or more sets of data can be compressed for storage and recovered with sufficient detail for use.

In some cases, the system can obtain the one or more sets of approved data to be included in the first IMP, e.g., from the client device or from a database the system is granted permissions to access. In other cases, the system can generate the one or more sets of approved data to be included in the first IMP, e.g., by generating the one or more sets of approved data based on interactions with at least one LLM among the one or more external LLMs. In particular, the system can generate a set of data that includes one or more prompt-response pairs of an example interaction with the at least one LLM. In yet another case, the system can obtain at least one of the sets of approved data, e.g., from a client device, and can generate at least one of the sets of approved data using at least one LLM.

In particular, in the case that the system generates at least one of the sets of approved data using an external LLM, the system can transmit a first set of instructions to the at least one external LLM to perform a first set of information processing, can receive a first set of results generated by the at least one LLM performing the first set of information processing, and can transmit a second set of instructions to the at least one LLM to perform a second set of information processing based on the first set of results and the second set of instructions. The system can then receive a second set of results generated by the at least one LLM performing the second set of information processing, and can define the second set of results as a first set of approved data among the one or more sets of approved data. More specifically, the system can insert the second set of results in to the first IMP package as one of the sets of approved data.

The system can insert one or more sets of approved data into the first IMP based on the package definition (step 320). In particular, the system can initialize a data structure corresponding with the first IMP and insert each given set of approved data at the level of fidelity corresponding to the assigned fidelity setting for the given set of approved data. For example, the system can use the package definition to determine whether each set of approved data should be inserted into the high or low fidelity memory in the first IMP.

The system can then assign a first version indicator to the first IMP (step 330), e.g., to uniquely identify the first IMP. For example, the unique identification can be used to identify the first IMP, e.g., for the purposes of generating a new IMP using the one or more sets of data in the first IMP. An example for generating a new version of an IMP will be described in more detail with respect to FIG. 4.

The system can provide the first IMP to one or more external LLMs (step 340), and, in response to receiving a request for processing using the first IMP, can instruct at least one of the LLMs to generate a response to the request using the first IMP (step 350). As an example, a request can include a prompt, e.g., a directive instruction, that relates to a context, e.g., to provide support details to aid the LLM in responding to the request. In particular, the system can instruct at least one LLM among the one or more external LLMs to generate a response to the request using the first IMP, e.g., as context, that was already provided to the at least one LLM without again providing the first IMP to the one or more external LLMs. More specifically, the system can save bandwidth, reduce latency, and maintain consistency over multiple queries for processing by providing the first IMP to the LLM one time for use in processing using the LLM, e.g., in contrast to providing the first IMP to the LLM each time in response to a request for processing using the first IMP or preparing the context dynamically with every call.

For example, the request can include an indication to use at least one of the sets of approved data in the first IMP as context for the request. In this case, the system can instruct the at least one LLM to generate a response to the request using the context for the request, e.g., to process the request and the at least one of the sets of approved data as context for the request. As an example, the request can identify the at least one set of approved data, e.g., by including an identification of a set of approved data, and the at least one LLM can identify the at least one of the sets of approved data in the first IMP for use as context in generating a response.

As another example, in the case that the request does not identify the set of approved data as context, the at least one LLM can identify the at least one of the sets of approved data in the first IMP as context by determining a respective measure of relevance with respect to the request for each of the sets of approved data in the first IMP. In particular, the LLM can determine the respective measures of relevance by generating a respective content embedding of each of the sets of approved data using an embedding neural network, can generate a request embedding of the request using the embedding neural network, and can determine the respective measures of similarity between the request embedding and each of the respective content embeddings as the respective measure of relevance for each of the one or more sets of approved data.

In an example implementation, an entity, e.g., a person or an organization, can submit a package definition for a first IMP to the system, e.g., to generate the first IMP that the entity and, e.g., any associated parties, can benefit from when submitting requests to an LLM in a controlled response generation environment. In some cases, the request can be a document analysis request of the entity. In this case, e.g., the first IMP can include one or more textual electronic documents, e.g., a file, a portion of the file, or multiple files that include(s) data that causes presentation of a set of textual content at a client device, and the entity can submit the document analysis request to the system, and the system can provide the document analysis request as input to at least one of the external LLMs for processing using the first IMP.

FIG. 4 is a flow diagram of an example process 400 for generating a new version of an IMP. For convenience, the process 400 will be described as being performed by a system of one or more computers located in one or more locations. For example, an LLM request management system, e.g., the LLM request management system 100 of FIG. 1, that is connected between a client device and one or more external large language models (LLMs) and is appropriately programmed in accordance with this specification, can perform the process 400. Operations of the process 400 can be implemented, for example, as instructions stored on one or more non-transitory computer-readable medium that, upon execution by one or more computing devices, cause the one or more computing devices to perform operations of the process 400.

The system can obtain any additional sets of approved data for a new version of an IMP (step 410). For example, the system can generate the new IMP version based on the one or more sets of approved data in a first IMP and a response generated by at least one LLM. As another example, the system can generate the new IMP version based on one or more additional sets of approved data, e.g., obtained from a client device.

The system can then add any additional sets of approved data to the one or more sets of approved data in a previous version of the IMP to obtain a new IMP (step 420). In particular, the system can identify the previous version of the IMP, e.g., the first IMP, can extract the one or more sets of approved data, add the additional sets of approved data, and can insert both the previous version data and the new data in an IMP, e.g., at the desired fidelity. More specifically, the system can add data from the response generated by the at least one LLM or the one or more additional sets of approved data to the one or more sets of approved data in the first IMP to obtain a new IMP.

For example, the system can initialize a data structure corresponding with the new IMP and can insert the sets of approved data from the first IMP and the additional sets of approved data into the new IMP. In particular, the system can insert each given set of approved data at the level of fidelity corresponding to the assigned fidelity setting for the given set of approved data. As an example, the system can use the package definition for the first IMP to determine which of the sets of approved data should be inserted into the high or low fidelity memory in the new IMP. As another example, the system can use a new package definition for the new IMP or a default fidelity setting to determine which of the additional sets of approved data should be inserted into the high or low fidelity memory in the new IMP.

The system can then assign a next version indicator to the new IMP (step 430). In particular, the system can assign a new version indicator to differentiate the new IMP from the first IMP. In some cases, the system can extract the unique version identifier of the previous version of the IMP and add a value, e.g., one, to increment the version identifier of the new IMP. In other cases, the system can assign a unique version identifier using a pseudorandom number generator, e.g., by ensuring that the generated identifier has not been previously assigned to another IMP.

As discussed with respect to FIG. 3, the system can then provide the new IMP to one or more external LLMs. In response to receiving a request for processing using the new IMP, the system can instruct at least one LLM to generate a response to the request using the new IMP. In particular, the system can instruct the at least one LLM to generate a response to a request using either the first IMP or the new IMP by specifying either the first version indicator for the first IMP or the new version indicator for the new IMP. In particular, the system can indicate which of the first IMP or the new IMP the at least one external LLM will use to perform the information processing without again providing either of the first IMP or the new IMP to the at least one external LLM.

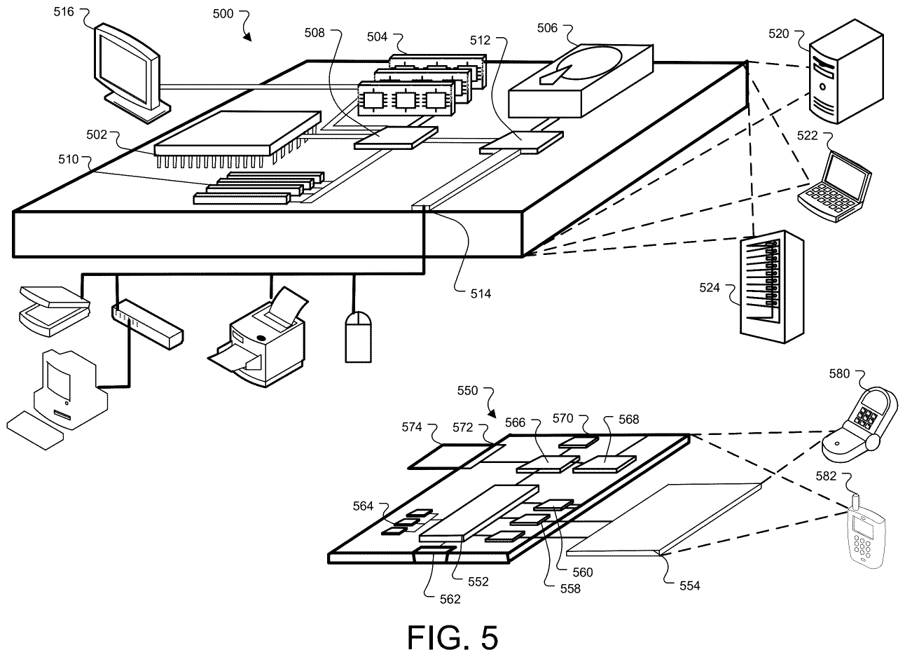

FIG. 5 shows an example of example computer device 500 and example mobile computer device 550, which can be used to implement the techniques described herein. For example, a portion or all of the operations for generating a first version of a first IMP and providing the first IMP to at least one external LLM, generating a second version of the first IMP, etc. may be executed by the computer device 500 and/or the mobile computer device 550. Computing device 500 is intended to represent various forms of digital computers, including, e.g., laptops, desktops, workstations, personal digital assistants, servers, blade servers, mainframes, and other appropriate computers. Computing device 550 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 500 includes processor 502, memory 504, storage device 506, high-speed interface 508 connecting to memory 504 and high-speed expansion ports 510, and low-speed interface 512 connecting to low-speed bus 514 and storage device 506. Each of components 502, 504, 506, 508, 510, and 512, are interconnected using various busses, and can be mounted on a common motherboard or in other manners as appropriate. Processor 502 can process instructions for execution within computing device 500, including instructions stored in memory 504 or on storage device 506 to display graphical data for a GUI on an external input/output device, including, e.g., display 516 coupled to high-speed interface 508. In other implementations, multiple processors and/or multiple busses can be used, as appropriate, along with multiple memories and types of memory. Also, multiple computing devices 500 can be connected, with each device providing portions of the necessary operations (e.g., as a server bank, a group of blade servers, or a multi-processor system).

Memory 504 stores data within computing device 500. In one implementation, memory 504 is a volatile memory unit or units. In another implementation, memory 504 is a non-volatile memory unit or units. Memory 504 also can be another form of computer-readable medium (e.g., a magnetic or optical disk. Memory 504 may be non-transitory.)

Storage device 506 is capable of providing mass storage for computing device 500. In one implementation, storage device 506 can be or contain a computer-readable medium (e.g., a floppy disk device, a hard disk device, an optical disk device, or a tape device, a flash memory or other similar solid state memory device, or an array of devices, such as devices in a storage area network or other configurations.) A computer program product can be tangibly embodied in a data carrier. The computer program product also can contain instructions that, when executed, perform one or more methods (e.g., those described above.) The data carrier is a computer-or machine-readable medium, (e.g., memory 504, storage device 506, memory on processor 502, and the like.)

High-speed controller 508 manages bandwidth-intensive operations for computing device 500, while low-speed controller 512 manages lower bandwidth-intensive operations. Such allocation of functions is an example only. In one implementation, high-speed controller 508 is coupled to memory 504, display 516 (e.g., through a graphics processor or accelerator), and to high-speed expansion ports 510, which can accept various expansion cards (not shown). In the implementation, low-speed controller 512 is coupled to storage device 506 and low-speed expansion port 514. The low-speed expansion port, which can include various communication ports (e.g., USB, Bluetooth®, Ethernet, wireless Ethernet), can be coupled to one or more input/output devices, (e.g., a keyboard, a pointing device, a scanner, or a networking device including a switch or router, e.g., through a network adapter.)

Computing device 500 can be implemented in a number of different forms, as shown in the figure. For example, it can be implemented as standard server 520, or multiple times in a group of such servers. It also can be implemented as part of rack server system 524. In addition or as an alternative, it can be implemented in a personal computer (e.g., laptop computer 522.) In some examples, components from computing device 500 can be combined with other components in a mobile device (not shown), e.g., device 550. Each of such devices can contain one or more of computing device 500, 550, and an entire system can be made up of multiple computing devices 500, 550 communicating with each other.

Computing device 550 includes processor 552, memory 564, an input/output device (e.g., display 554, communication interface 566, and transceiver 568) among other components. Device 550 also can be provided with a storage device, (e.g., a microdrive or other device) to provide additional storage. Each of components 550, 552, 564, 554, 566, and 568, are interconnected using various buses, and several of the components can be mounted on a common motherboard or in other manners as appropriate.

Processor 552 can execute instructions within computing device 550, including instructions stored in memory 564. The processor can be implemented as a chipset of chips that include separate and multiple analog and digital processors. The processor can provide, for example, for coordination of the other components of device 550, e.g., control of user interfaces, applications run by device 550, and wireless communication by device 550.

Processor 552 can communicate with a user through control interface 558 and display interface 556 coupled to display 554. Display 554 can be, for example, a TFT LCD (Thin-Film-Transistor Liquid Crystal Display) or an OLED (Organic Light Emitting Diode) display, or other appropriate display technology. Display interface 556 can comprise appropriate circuitry for driving display 554 to present graphical and other data to a user. Control interface 558 can receive commands from a user and convert them for submission to processor 552. In addition, external interface 562 can communicate with processor 542, so as to enable near area communication of device 550 with other devices. External interface 562 can provide, for example, for wired communication in some implementations, or for wireless communication in other implementations, and multiple interfaces also can be used.

Memory 564 stores data within computing device 550. Memory 564 can be implemented as one or more of a computer-readable medium or media, a volatile memory unit or units, or a non-volatile memory unit or units. Expansion memory 574 also can be provided and connected to device 550 through expansion interface 572, which can include, for example, a SIMM (Single In Line Memory Module) card interface. Such expansion memory 574 can provide extra storage space for device 550, or also can store applications or other data for device 550. Specifically, expansion memory 574 can include instructions to carry out or supplement the processes described above, and can include secure data also. Thus, for example, expansion memory 574 can be provided as a security module for device 550, and can be programmed with instructions that permit secure use of device 550. In addition, secure applications can be provided through the SIMM cards, along with additional data, (e.g., placing identifying data on the SIMM card in a non-hackable manner.)

The memory 564 can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer-or machine-readable medium (e.g., memory 564, expansion memory 574, and/or memory on processor 552), which can be received, for example, over transceiver 568 or external interface 562.

Device 550 can communicate wirelessly through communication interface 566, which can include digital signal processing circuitry where necessary. Communication interface 566 can provide for communications under various modes or protocols (e.g., GSM voice calls, SMS, EMS, or MMS messaging, CDMA, TDMA, PDC, WCDMA, CDMA2000, or GPRS, among others.) Such communication can occur, for example, through radio-frequency transceiver 568. In addition, short-range communication can occur, e.g., using a Bluetooth®, WiFi, or other such transceiver (not shown). In addition, GPS (Global Positioning System) receiver module 570 can provide additional navigation-and location-related wireless data to device 550, which can be used as appropriate by applications running on device 550. Sensors and modules such as cameras, microphones, compasses, accelerators (for orientation sensing), etc. may be included in the device.

Device 550 also can communicate audibly using audio codec 560, which can receive spoken data from a user and convert it to usable digital data. Audio codec 560 can likewise generate audible sound for a user, (e.g., through a speaker in a handset of device 550.) Such sound can include sound from voice telephone calls, can include recorded sound (e.g., voice messages, music files, and the like) and also can include sound generated by applications operating on device 550.

Computing device 550 can be implemented in a number of different forms, as shown in the figure. For example, it can be implemented as cellular telephone 580. It also can be implemented as part of smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A computer-implemented method, comprising:
obtaining, by a system that is connected between a client device and one or more external large language models (LLMs), a package definition for a first immutable memory package (IMP), wherein the definition of the first IMP specifies one or more sets of approved data to be included in the first IMP, and for each of the one or more sets of approved data, an assigned fidelity setting indicating a level of fidelity at which the set of approved data will be included in the first IMP;
inserting, by the system and based on the package definition, the one or more sets of approved data into the first IMP, wherein each given set of approved data is inserted at the level of fidelity corresponding to the assigned fidelity setting for the given set of approved data;
assigning, by the system, a first version indicator to the first IMP, wherein the first version indicator uniquely identifies the first IMP that includes the stored one or more sets of approved data;
providing, by the system, the first IMP to the one or more external LLMs;
after providing the first IMP to the one or more external LLMs, receiving, by the system, a request for processing using the first IMP from the client device;
in response to receiving the request, instructing, by the system, at least one LLM from among the one or more external LLMs to generate a response to the request using the first IMP that was already provided to the at least one LLM without again providing the first IMP to the one or more external LLMs.

2. The computer-implemented method of claim 1, further comprising generating the one or more sets of approved data based on interactions with at least one LLM among the one or more external LLMs.

3. The computer-implemented method of claim 2, wherein generating the one or more sets of approved data comprises:
transmitting a first set of instructions to the at least one LLM to perform a first set of information processing;
receiving a first set of results generated by the at least one LLM performing the first set of information processing;
transmitting a second set of instructions to the at least one LLM to perform a second set of information processing based on the first set of results and the second set of instructions;
receiving a second set of results generated by the at least one LLM performing the second set of information processing; and
defining the second set of results as a first set of approved data among the one or more sets of approved data, wherein inserting the one or more sets of approved data into the first IMP comprises inserting the second set of results into the first IMP.

4. The computer-implemented method of claim 1, further comprising generating a new IMP version based on the one or more sets of approved data in the first IMP and a response generated by at least one LLM.

5. The computer-implemented method of claim 4, wherein generating the new IMP version comprises:
adding data from the response generated by the at least one LLM to the one or more sets of approved data in the first IMP to obtain a new IMP;
assigning, to the new IMP, a new version indicator that uniquely identifies the new IMP and differentiates the new IMP from the first IMP; and
providing the new IMP to the one or more external LLMs.

6. The computer-implemented method of claim 5, further comprising instructing at least one external LLM among the one or more external LLMs to perform information processing, wherein the instructions specify one of the first version indicator or the new version indicator as an indication of which of the first IMP or the new IMP the at least one external LLM will use to perform the information processing without again providing either of the first IMP or the new IMP to the at least one external LLM.

7. The computer-implemented method of claim 1, further comprising obtaining the one or more sets of approved data to be included in the first IMP.

8. The computer-implemented method of claim 1, further comprising:
obtaining one or more additional sets of approved data from the client device;
adding the one or more additional sets of approved data to the one or more sets of approved data in the first IMP to obtain a new IMP;
assigning, to the new IMP, a new version indicator that uniquely identifies the new IMP and differentiates the new IMP from the first IMP; and
providing the new IMP to the one or more external LLMs.

9. The computer-implemented method of claim 1, wherein the request further comprises an indication to use at least one of the sets of approved data in the first IMP as context for the request, and wherein, in response to receiving the request, instructing, by the system, further comprises instructing the at least one LLM to generate a response to the request using the context for the request.

10. The computer-implemented method of claim 9, wherein the indication to use at least one of the sets of approved data further comprises the identification of the at least one of the sets of approved data, and wherein the at least one LLM generates a response to the request using the context for the request through operations comprising:
identifying the at least one of the sets of approved data in the first IMP as the context for the request.

11. The computer-implemented method of claim 9, wherein the at least one LLM identifies the at least one of the sets of approved data in the first IMP as context through operations comprising:
determining a respective measure of relevance with respect to the request for each of the sets of approved data in the first IMP;
selecting the at least one set of approved data from the first IMP based on the respective measures of relevance.

12. The computer-implemented method of claim 11, wherein determining the respective measures of relevance with respect to the request for each of the sets of relevant data comprises:
generating a respective content embedding of each of the sets of approved data using an embedding neural network;
generating a request embedding of the request using the embedding neural network;
determining the respective measures of similarity between the request embedding and each of the respective content embeddings as the respective measure of relevance for each of the one or more sets of approved data.

13. A system comprising one or more computers and one or more storage devices storing instructions that are operable, when executed by the one or more computers, to cause the one or more computers to perform operations comprising:
obtaining, by a system that is connected between a client device and one or more external large language models (LLMs), a package definition for a first immutable memory package (IMP), wherein the definition of the first IMP specifies one or more sets of approved data to be included in the first IMP, and for each of the one or more sets of approved data, an assigned fidelity setting indicating a level of fidelity at which the set of approved data will be included in the first IMP;
inserting, by the system and based on the package definition, the one or more sets of approved data into the first IMP, wherein each given set of approved data is inserted at the level of fidelity corresponding to the assigned fidelity setting for the given set of approved data;
assigning, by the system, a first version indicator to the first IMP, wherein the first version indicator uniquely identifies the first IMP that includes the stored one or more sets of approved data;
providing, by the system, the first IMP to the one or more external LLMs;
after providing the first IMP to the one or more external LLMs, receiving, by the system, a request for processing using the first IMP from the client device;
in response to receiving the request, instructing, by the system, at least one LLM from among the one or more external LLMs to generate a response to the request using the first IMP that was already provided to the at least one LLM without again providing the first IMP to the one or more external LLMs.

14. The system of claim 13, wherein the first IMP comprises:
a high-fidelity memory configured to store a first subset of the one or more content data items; and
a low-fidelity memory configured to store a second subset of the one or more content data items with less detail than the high-fidelity memory.

15. The system of claim 13, wherein the operations further comprise:
generating a new IMP version based on the one or more sets of approved data in the first IMP and a response generated by at least one LLM.

16. The system of claim 15, wherein generating the new IMP version comprises:
adding data from the response generated by the at least one LLM to the one or more sets of approved data in the first IMP to obtain a new IMP;
assigning, to the new IMP, a new version indicator that uniquely identifies the new IMP and differentiates the new IMP from the first IMP; and
providing the new IMP to the one or more external LLMs.

17. A computer storage medium encoded with a computer program, the program comprising instructions that are operable, when executed by data processing apparatus, to cause the data processing apparatus to perform operations comprising:
obtaining, by a system that is connected between a client device and one or more external large language models (LLMs), a package definition for a first immutable memory package (IMP), wherein the definition of the first IMP specifies one or more sets of approved data to be included in the first IMP, and for each of the one or more sets of approved data, an assigned fidelity setting indicating a level of fidelity at which the set of approved data will be included in the first IMP;
inserting, by the system and based on the package definition, the one or more sets of approved data into the first IMP, wherein each given set of approved data is inserted at the level of fidelity corresponding to the assigned fidelity setting for the given set of approved data;
assigning, by the system, a first version indicator to the first IMP, wherein the first version indicator uniquely identifies the first IMP that includes the stored one or more sets of approved data;
providing, by the system, the first IMP to the one or more external LLMs;
after providing the first IMP to the one or more external LLMs, receiving, by the system, a request for processing using the first IMP from the client device;
in response to receiving the request, instructing, by the system, at least one LLM from among the one or more external LLMs to generate a response to the request using the first IMP that was already provided to the at least one LLM without again providing the first IMP to the one or more external LLMs.

18. The computer storage medium of claim 17, wherein the first IMP comprises:
a high-fidelity memory configured to store a first subset of the one or more content data items; and
a low-fidelity memory configured to store a second subset of the one or more content data items with less detail than the high-fidelity memory.

19. The computer storage medium of claim 17, wherein the operations further comprise:
generating a new IMP version based on the one or more sets of approved data in the first IMP and a response generated by at least one LLM.

20. The computer storage medium of claim 19, wherein generating the new IMP version comprises:
adding data from the response generated by the at least one LLM to the one or more sets of approved data in the first IMP to obtain a new IMP;
assigning, to the new IMP, a new version indicator that uniquely identifies the new IMP and differentiates the new IMP from the first IMP; and
providing the new IMP to the one or more external LLMs.
